(19) United States
(12) Patent Application Publication
(10) Pub. No.: US 2012/0224579 A1
(43) Pub. Date: Sep. 6, 2012

(54) Multiprotocol Label Switching (MPLS) Virtual Private Network (VPN) Over Routed Ethernet Backbone

(75) Inventor: Peter Ashwood-Smith, Gatineau (CA)

(73) Assignee: FUTUREWEI TECHNOLOGIES, INC., Plano, TX (US)

(21) Appl. No.: 13/100,518

(22) Filed: May 4, 2011

Related U.S. Application Data
(60) Provisional application No. 61/447,748, filed on Mar. 1, 2011.

(51) Int. Cl. H04L 12/56

(52) U.S. Cl. 370/392

(57) ABSTRACT

In at least some embodiments, a network includes a plurality of switches and/or routers configured to implement a native Ethernet routing protocol that encapsulates virtual private network (VPN) traffic with an encapsulation attachment point Ethernet source address, with a de-encapsulation attachment point Ethernet destination address, and with a service label that uniquely identifies the VPN within the network. A single link state protocol such as IS-IS is used to carry network topology and service attachment point information.

### CROSS-REFERENCE TO RELATED APPLICATIONS

The present application claims the benefit of U.S. Provisional Patent Application No. 61/447,748, filed Mar. 1, 2011 by Peter Ashwood-Smith, and entitled “Multiprotocol Label Switching Virtual Private Network Over Routed Ethernet Backbone,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern communications and data networks are comprised of nodes that transport data through the network. The nodes may include routers, switches, bridges, or combinations thereof that transport the individual data packets or frames through the network. Some networks may offer data services that forward data frames from one node to another node across the network without using pre-configured routes on the intermediate nodes. Other networks may forward the data frames from one node to another node across the network along pre-configured or pre-established paths. In some networks, the nodes may create Ethernet-Local Area Network (E-LAN) services, where traffic that corresponds to different services may be transported along different sub-networks (e.g., by different subsets of nodes). For example, the E-LAN services may comprise Institute of Electrical and Electronics Engineers (IEEE) 802.1aq/0.1Qbp network services or Virtual Private LAN Services (VPLS).

Due to the demand for high speed data transport and the ability to support high-bandwidth transmission rates, many data network devices are deployed with the capability to switch at Layer-2 and Layer-3 in hardware. Layer-2 switching devices may be deployed to alleviate switching bottlenecks within subnets of a LAN environment. Meanwhile, layer-3 switching devices may be deployed to alleviate bottlenecks in Layer-3 routing by moving the route lookup for Layer-3 forwarding to high-speed switching hardware.

Multiprotocol Label Switching (MPLS) is an Internet Engineering Task Force (IETF)-specified framework that provides for the efficient designation, routing, forwarding, and switching of traffic flows through a network. In an MPLS network, incoming packets are assigned a “label” by a label edge router (LER). Packets are forwarded along a label switch path (LSP) where label switch routers (LSRs) makes forwarding decisions based solely on the contents of the label and the port the packet arrived on. At each hop, an LSR strips off the existing label and applies a new label which tells the next hop how to forward the packet.

LSPs are established by network operators for a variety of purposes, such as to guarantee a certain level of performance, to route around network congestion, or to create tunnels for network-based virtual private networks (VPNs). In many ways, LSPs are no different than circuit-switched paths in Asynchronous Transfer Mode (ATM) or Frame Relay networks, except that they are not dependent on a particular Layer-2 technology. An LSP can be established using MPLS that crosses multiple Layer-2 transports such as ATM, Frame Relay, or Ethernet.

FIG. 1 is a chart 100 showing label-based communications in a network. In FIG. 1, an ingress node (labeled ‘I’) 102, a transit node (labeled ‘T’) 104, and an egress node (labeled ‘E’) 106 are shown. In FIG. 1, control flows are implemented. More specifically, use of Label Distribution Protocol (LDP) and Border Gateway Protocol (BGP) are shown in FIG. 1 to unidirectionally advertise labels. One of the labels (label 6) is for the service (VPN 44) and is used in the context of the egress node ‘E’ 106. Meanwhile, label 88 is used by egress node 106 to represent itself to its transit node (labeled ‘T’) 104, which advertises a different/switched label upstream to ingress node ‘I’ 102, where label 99 is used.

After the control flows (LDP and BGP) set up use of the labels, the data flow (shown in dashed lines) occurs in FIG. 1. As shown, the VPN traffic XX arrives to ingress node 102 and, based on the context, is assigned routing label 99 and service label 6. At the transit node 104, routing label 99 is swapped to label 88 and the VPN traffic is forwarded to the egress node 106. The egress node 106 then looks up the locally significant service label 6 to find the virtual routing table (VRF), which is used to forward the de-encapsulated VPN traffic XX outside the context of the backbone MPLS network.

The technique of FIG. 1 may be referred to as MPLS VPN. In MPLS VPN, two layers of MPLS labels are present before the VPN specific headers (VPLS or Internet Protocol (IP) VPN/2547). The first MPLS label identifies how to route the packet while the second MPLS label is a node specific indication of the VPN of which this packet is a member. The LDP protocol is used to advertise the first layer of labeling. Alternatively, a Resource Reservation Protocol (RSVP)-Traffic Engineering (TE) protocol can be used to advertise the first (routing) layer of labeling. The second layer of labeling is used as a (service) association label(s) and is advertised either with BGP or an additional level of LDP. In the technique of FIG. 1, the MPLS labels have local meaning only.

### SUMMARY

In one embodiment, the disclosure includes a network comprising a plurality of switches and/or routers configured to implement a native Ethernet routing protocol. The native Ethernet routing protocol encapsulates VPN traffic with an encapsulation attachment point Ethernet source address, with a de-encapsulation attachment point Ethernet destination address, and with a service label that uniquely identifies the VPN within the network.

In another embodiment, the disclosure includes a network component comprising an Ethernet routing module. The Ethernet routing module is configured to encapsulate VPN traffic with an encapsulation attachment point Ethernet source address of the Ethernet routing module, with a de-encapsulation attachment point Ethernet destination address, and with a service label that uniquely identifies the VPN within a network associated with the network component.

In a third embodiment, the disclosure includes a method comprising receiving, by a processor, a VPN packet. The method also comprises encapsulating the VPN packet with an encapsulation attachment point Ethernet source address, with a de-encapsulation attachment point Ethernet destination address, and with a service label that uniquely identifies the VPN within a network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a chart showing label-based communications in a network.

FIG. 2 is a chart showing MPLS VPN communications over a routed Ethernet backbone.

FIG. 3 is a schematic diagram of an embodiment of an E-LAN service based network.

FIG. 4 is a flowchart of a method for MPLS VPN communications over a routed Ethernet backbone.

FIG. 5 is a schematic diagram of an embodiment of a transmitter/receiver unit.

FIG. 6 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any quantity of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are network embodiments that provide the ability to route Ethernet frames and to encapsulate a VPN frame (e.g., either Layer 2 or Layer 3) with a MPLS header such that the label uniquely identifies the VPN within the scope of the routed Ethernet network. In at least some embodiments, the Ethernet frames are routed via shortest paths and are forwarded hop-by-hop based on an Ethernet Destination Address and virtual local area network (VLAN) identifier (VID) over multiple hops (e.g., using 802.1aq/0.1Qbp Shortest Path Bridging).

The disclosed technique is different from existing MPLS Layer 2 (L2)/Layer 3 (L3) VPNs because there is no MPLS layer used for the backbone routing. Rather, the disclosed backbone routing is based on Ethernet, which eliminates a complete layer of MPLS (e.g., LDP operations are not needed). Further, the MPLS “service” label identifies the VPN throughout the network (backbone) and does not change. As a result, there is no need to advertise per node/per VPN values, which eliminates another layer of MPLS control (e.g., Border Gateway Protocol (BGP) operations are not needed). The end result is that a single routed Ethernet control plane can provide L2 VPNs as per 802.1aq/0.1Qbp, and can also provide L2 and L3 VPN's as per MPLS but with a single control plane (e.g., Intermediate System To Intermediate System (IS-IS) may be used) and with a simple data plane that works on existing hardware.

In at least some embodiments, the disclosed technique is applied to a Service Provider Data Center, in which L2 and L3 VPN functionality is desired, but without the complexity of MPLS. When L2 and L3 VPNs are employed in Service Provider networks, large scale VPN implementations may necessitate 2-3 MPLS protocols used in combination to create a 2 level label stack. For scalability reasons (the scale of the Internet), the MPLS labels have local significance and may be advertised in several different protocols so that the ingress and egress devices can identify the proper label value to use for a given VPN. The use of multiple MPLS protocols for VPNs in a large scale network environment requires considerable expertise to operate due to the multiple protocols involved. Further, such VPNs may be hard to debug given that the label values change and have meanings, which may be substantially context dependent.

In accordance with at least some embodiments, L2 and L3 VPNs are supported in a modern Data Center configured by a service provider to allow Virtual Private Data Center functions. In such embodiments, the Data Center may support various L2 functions to enable L2 broadcasts such that data center (DC) applications can easily find co-operating instances among other uses of the broadcast. To support L2 connectivity for Data Center networks, routed Ethernet protocols may be utilized (e.g., The Institute of Electrical and Electronics Engineers (IEEE) standard 802.1aq/0.1Qpb for Shortest Path Bridging). To support L3 VPNs, a modern Data Center may use the Ethernet media access control (mac)-in-mac header to uniquely identify the route and also the VPN membership. This is technically feasible but is not usually supported on the application-specific integrated circuit's (ASIC's) that are available on the targeted inexpensive hardware.

Accordingly, disclosed embodiments use a single MPLS header directly on top of a routed Ethernet header. In this manner, a packet can be routed normally across the Ethernet network, which can now be substantially utilized because it is a routed network, and once it reaches the egress node, it can be forwarded on the MPLS VPN service label normally. One advantage with the disclosed technique is that every member of that VPN may use the same VPN service label. In at least some embodiments, the disclosed combination of using routed Ethernet and non-context dependent service labels eliminates all routing protocols (e.g., LDP and BGP), except protocols needed to build the routed Ethernet layer. The disclosed combination of using routed Ethernet and non-context dependent service labels also makes debugging of the network easier and allows L2 and L3 MPLS-style VPNs to operate over a routed Ethernet infrastructure without hardware changes.

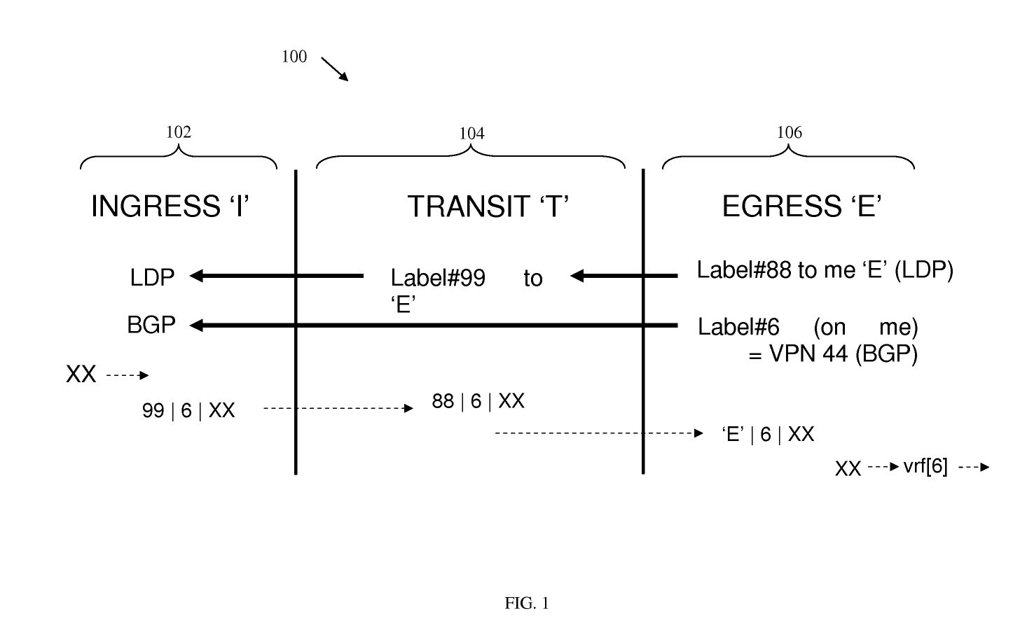

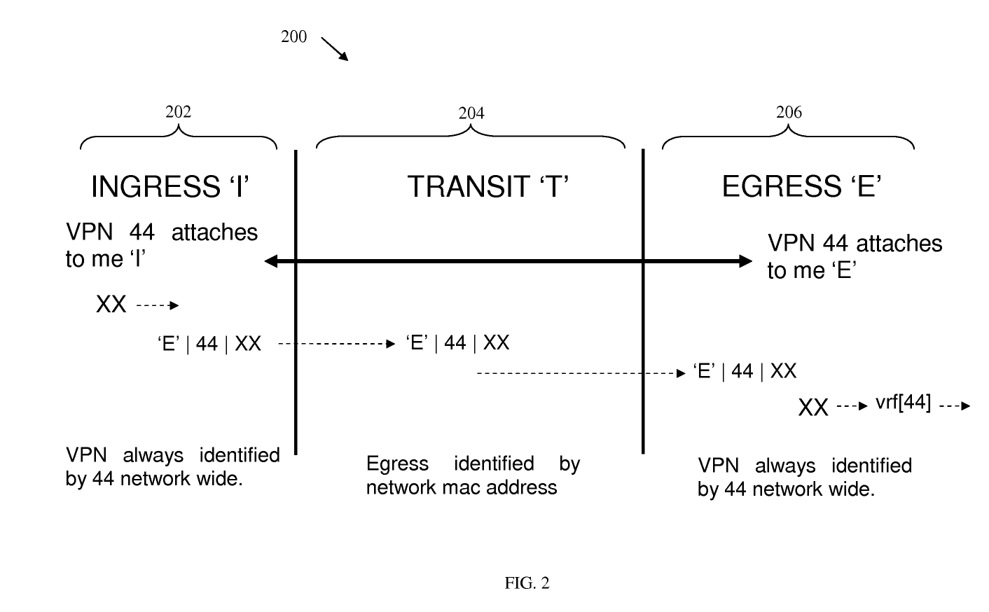

FIG. 2 is a chart 200 showing MPLS VPN communications over a routed Ethernet backbone. In FIG. 2, an ingress node (labeled ‘I’) 202, a transit node (labeled ‘T’) 204, and an egress node (labeled ‘E’) 206 are shown, where a different control flow is implemented compared to the control flow in FIG. 1. More specifically, a single protocol, such as IS-IS, may not only advertise the MAC addresses of the ingress node 202 and the egress node 206, but also the fact that both have membership in VPN 44. Accordingly, in at least some embodiments, only one protocol is needed to advertise both routing and service attachment. In this manner, the service identifiers and routing identifiers may be invariant within the context of the backbone network.

The change in the control flow for FIG. 2 is manifested on the data path (the dashed lines). First, the frame XX is encapsulated at ingress node 202 with two unchanging identifiers. In FIG. 2, ‘E’ is the MAC address of the egress node 206 and “44” is the VPN in question. This means that the transit node 204 never changes the frame and any debugging/snooping or Operations, Administration, and Management (OA&M) actions on transit node 204 can identify what the frame is doing without knowing the context of the end nodes. When the frame arrives at egress node 206, it is de-encapsulated and the VPN identifier given by the label is used to find the VRF for proper forwarding of the VPN traffic XX.

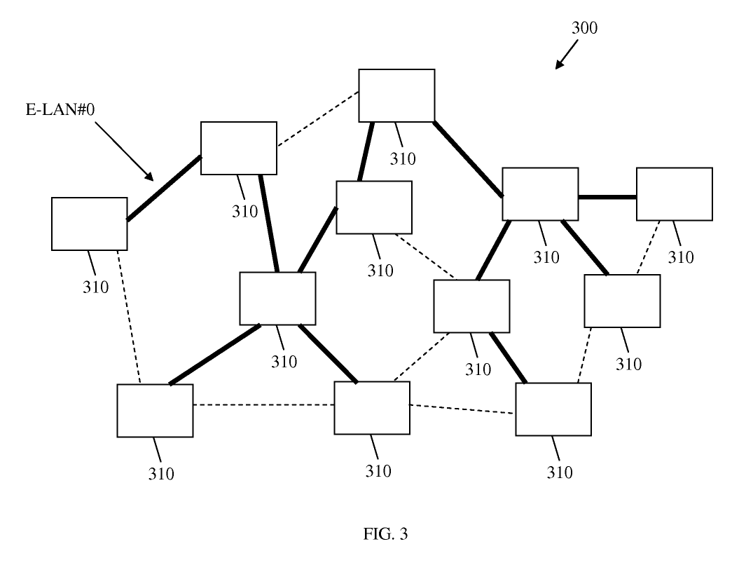

FIG. 3 is a schematic diagram of an embodiment of an E-LAN service based network 300. The E-LAN service based network 300 may comprise a plurality of nodes 310, which may comprise switches, routers, bridges, or combinations thereof. The nodes 310 may each comprise a plurality of logical and/or physical ports and may be coupled to each other via the ports and a plurality of network links (indicated by the dashed lines). The E-LAN service based network 300 may be any network that establishes E-LAN services between the nodes 310, such as an 802.1aq/0.1Qbp or VPLS networks. The E-LAN services may correspond to logical Ethernet point-to-point (ptp) or point-to-multipoint (ptmp) sub-networks that may be established between the nodes 310 to facilitate service forwarding between the associated nodes 310.

For example, an E-LAN service may be established between a subset of the nodes 310 (indicated by the bold solid lines). The E-LAN service may be used to forward service traffic between the subset of nodes 310, for instance by binding the service to a unique identifier of the E-LAN service (e.g., ELAN#0) without using the individual node addresses. Additionally or alternatively, the E-LAN service based network 300 may establish other services similar to the E-LAN services, such as an Ethernet Line (E-Line) service for ptp communications and/or an Ethernet Tree (E-Tree) service for ptmp communications.

In accordance with embodiments, at least some of the nodes 310 correspond to an Ethernet “backbone” network of switches/routers. The Ethernet backbone is capable of computing shortest paths and creating forwarding tables, such that an Ethernet Destination Address and a VID enables an Ethernet frame to be forwarded one hop closer to that Destination Address along one of several possible shortest paths. For example, the Ethernet backbone may implement IEEE 802.1aq/0.1Qbp Shortest Path Bridging.

In at least some embodiments, a backbone wide value that uniquely identifies a VPN instance that may fit in a MPLS label field (all members of the VPN may use the same value) is defined and managed. The identified VPN instance is then advertised as a MPLS label value using an Ethernet routing protocol (e.g., IS-IS). The MPLS label value is implicitly associated with an Ethernet Destination Address where de-encapsulation is to occur (i.e., the VPN's attachment points onto the Ethernet backbone). At the ingress attachment point node (e.g., the ingress node 202) of such an Ethernet backbone network, a layer 2 or layer 3 VPN packet is received and encapsulated such that the outer header is a native Ethernet header that causes the VPN packet to be routed to the proper de-encapsulation attachment point(s) and the second header is an MPLS label which identifies the VPN (within the backbone), followed by the actual VPN specific header (L3 or L2). The frame is forwarded hop-by-hop within the Ethernet backbone based on the outer Ethernet Destination Address and VID until the de-encapsulation attachment point node is reached. At the de-encapsulation attachment point node (i.e., the egress node 206 of the Ethernet backbone) of the Ethernet backbone network, a MPLS label is used to directly determine which VRF or Virtual Forwarding Instance (VFI) may be used to continue the L3 or L2 forwarding operation.

To summarize, a network (e.g., the E-LAN service network 300) as disclosed herein may comprise a plurality of switches and/or routers configured to implement a native Ethernet routing protocol. In at least some embodiments, the plurality of switches or routers are identified as components of an Ethernet backbone. The Ethernet routing protocol encapsulates VPN traffic with an encapsulation attachment point Ethernet source address, with a de-encapsulation attachment point Ethernet destination address, and with a service label (e.g., a multi-protocol label switching (MPLS) header) that uniquely identifies the VPN within the network (e.g., an Ethernet backbone). As an example, the encapsulation attachment point Ethernet source address may correspond to a source Media Access Control (MAC) address (of an ingress node of an Ethernet backbone) and the de-encapsulation attachment point Ethernet destination address may correspond to a destination MAC address (of an egress node of an Ethernet backbone). The use of the disclosed Ethernet routing protocol eliminates use of LDP operations and/or BGP operations in the network. Further, the use of the disclosed Ethernet routing protocol eliminates use of egress-specific VPN labels in the network. In at least some embodiments, the plurality of switches and/or routers are configured to forward encapsulated VPN traffic to a destination MAC address using a shortest path protocol without transit modification of the frames after encapsulation until de-encapsulation. The switches and/or routers are configured to correlate, for a VPN label, the network address space to VPN address space reachability relationships for at least one layer 2 VPN transported over the network. A reachability relationship is the knowledge that a given VPN member's address (e.g., C) is reachable via a given network node address (e.g., N). In other words, the reachability relationship may be described as a table of <C, N> for each of the VPNs supported.

In at least some embodiments, the disclosed network corresponds to a shortest path routed Ethernet network (e.g., based on 802.1aq/0.1Qbp), where a network wide global MPLS label that maps 1:1 to a VPN identifier is used. Further, the use of the global MPLS label identifier is advertised in the routed Ethernet network using a routing protocol such as IS-IS. Thereafter, VPN traffic may be encapsulated with a MPLS backbone wide unique label identifier and then with a routed Ethernet header. The encapsulated VPN packet is subsequently forwarding over a routed Ethernet backbone multiple hops along a shortest path. At the egress node of the routed Ethernet backbone, the frame being forwarded is de-encapsulated, where the backbone wide unique MPLS label is used to identify the VPN context for further forwarding after de-encapsulation outside the routed Ethernet backbone.

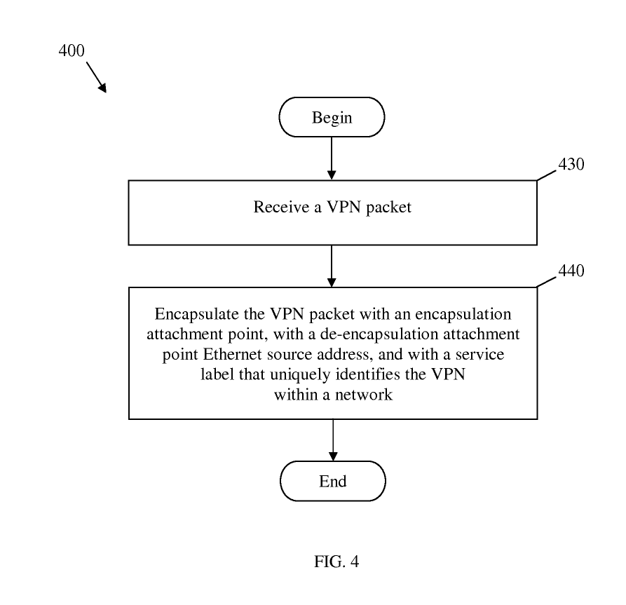

FIG. 4 is a flowchart of a method 400 for MPLS VPN communications over a routed Ethernet backbone. The method 400 may be implemented by a network, a network server, a network management plane, one or more nodes in the network, or combinations thereof. The method 400 may begin at block 430, where a VPN packet is received. For instance, the VPN packet may be received by an ingress node of an Ethernet backbone network. At block 440, the VPN packet is encapsulated with an encapsulation attachment point Ethernet source address (e.g., an origination MAC address), with a de-encapsulation attachment point Ethernet destination address (e.g., a destination MAC address), and with a service label (e.g., a MPLS header) that uniquely identifies the VPN within the network. The method 400 may then end. For each VPN, the method 400 enables correlating a network address space to VPN address space reachability relationships for at least one layer 2 VPN transported over the network.

In at least some embodiments, the method 400 may additionally comprise identifying an Ethernet backbone of the network and using the service label to uniquely identify the VPN within the Ethernet backbone. Further, the method 400 may additionally comprise determining an Ethernet backbone wide value to uniquely identify a VPN instance that may fit in a MPLS label field (all members of the VPN may use the same value), and advertising the VPN instance as a MPLS label value using an Ethernet routing protocol (e.g., IS-IS). As previously discussed, the MPLS label value is implicitly associated with the Ethernet Destination Address where de-encapsulation is to occur (i.e., the VPN's attachment points onto the Ethernet backbone).

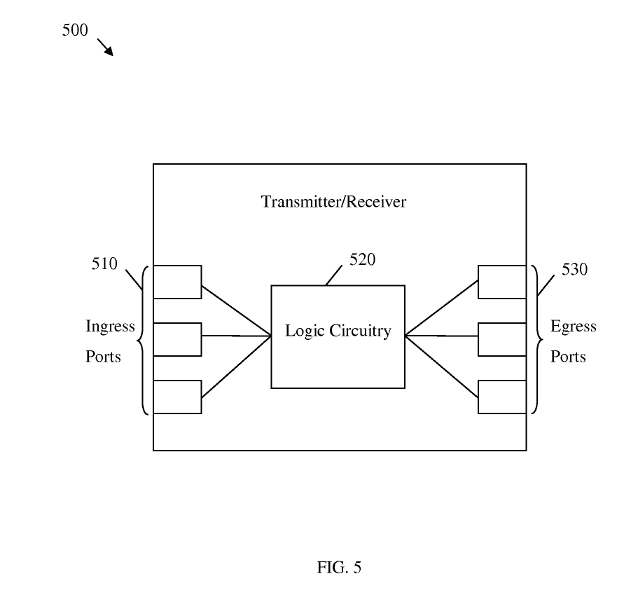

At least some of the features/methods described in the disclosure may be implemented in a network apparatus or component, such as a network node. For instance, the features/methods in the disclosure may be implemented using hardware, firmware, and/or software installed to run on hardware. The network apparatus/component or node may be any device that transports frames through a network, e.g. a switch, router, bridge, server, etc. FIG. 5 illustrates an embodiment of a transmitter/receiver unit 500, which may be located at or coupled to any of the components described above (e.g., in the E-LAN service network 300). The transmitter/receiver unit 500 may be any device that transports data through the network. For instance, the transmitter/receiver unit 500 may correspond to or may be located in any of the nodes 310.

As shown in FIG. 5, the transmitted/receiver unit 500 may comprise a plurality of ingress ports or units 510 for receiving frames, objects, or type-length-values (TLVs) from other nodes, logic circuitry 520 to determine which nodes to send the frames to, and a plurality of egress ports or units 530 for transmitting frames to the other nodes. The transmitter/receiver unit 500 may also comprise a buffer (not shown) between the ingress ports 510 and the logic circuit 520 and/or between the logic circuit 520 and the egress ports 530.

In accordance with at least some embodiments, the logic circuitry 520 comprises an Ethernet routing module configured to encapsulate VPN traffic with an encapsulation attachment point Ethernet source address of the Ethernet routing module, with a de-encapsulation attachment point Ethernet destination address, and with a service label that uniquely identifies the VPN within a network associated with the network component. As an example, the service label may correspond to MPLS header, the encapsulation attachment point Ethernet source address may correspond to an origination MAC address of the Ethernet routing module, and the de-encapsulation attachment point Ethernet destination address may correspond to a destination MAC address. If the network apparatus 500 is part of a network backbone, the service label uniquely identifies the VPN within the network backbone.

In at least some embodiments, the Ethernet routing module corresponding to logic circuitry 520 is configured to correlate, for a VPN label, a network address space to VPN address space reachability relationships for at least one layer 2 VPN transported over the network. Before such correlation, the Ethernet routing module may be identified as part of an Ethernet backbone that uses a given service label to uniquely identify each VPN within the Ethernet backbone. For example, each VPN instance may be previously advertised as a MPLS label value using an Ethernet routing protocol (e.g., IS-IS), where the MPLS label value is implicitly associated with the Ethernet Destination Address where de-encapsulation is to occur (i.e., the VPN's attachment points onto the Ethernet backbone). Advantageously, the Ethernet routing module corresponding to logic circuitry 520 avoids LDP operations, BGP operations, and egress-specific VPN labels.

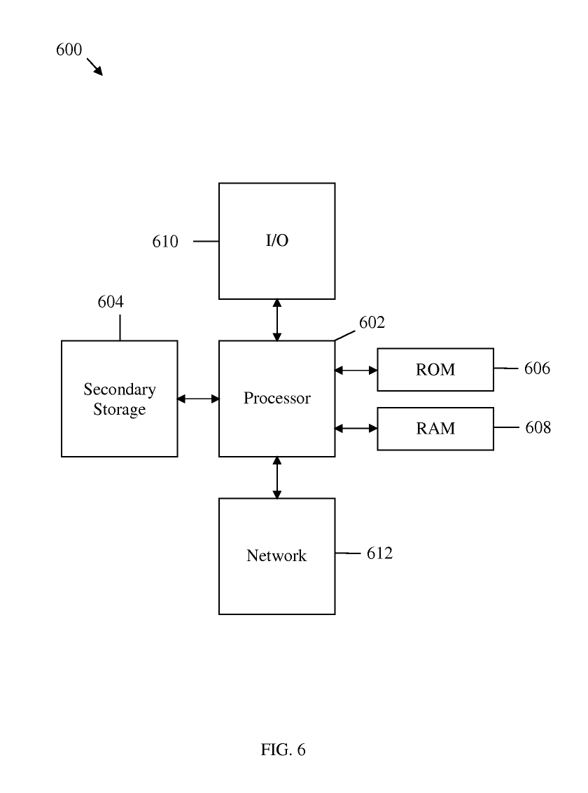

The network components (e.g., the nodes 310) described above may be implemented on any general-purpose network component, such as a computer or network component with sufficient processing power, memory resources, and network throughput capability to handle the necessary workload placed upon it. FIG. 6 illustrates a typical, general-purpose network component 600 suitable for implementing one or more embodiments of the components disclosed herein. The network component 600 includes a processor 602 (which may be referred to as a Central Processing Unit (CPU) that is in communication with memory devices including secondary storage 604, read only memory (ROM) 606, random access memory (RAM) 608, input/output (I/O) devices 610, and network connectivity devices 612). The processor 602 may be implemented as one or more CPU chips, or may be part of one or more ASICs.

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage. The RAM 608 is used to store volatile data and perhaps to store instructions. Access to both ROM 606 and RAM 608 is typically faster than to secondary storage 604.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The following references are included in the disclosure and incorporated herein by reference:
1. Institute of Electrical and Electronics Engineers (IEEE) 802.1Q-2005.
2. IEEE 802.1aq draft 1.5.
3. The Internet Engineering Task Force (IETF)/All L2 VPN and L3 VPN documents including Request for Comment (RFC) 2547.
4. Provider link state bridging by Allan, D.; Ashwood-Smith, P.; Bragg, N.; Fedyk, D. in Communications Magazine, IEEE Volume 46, Issue 9, September 2008 Page(s): 110-117 Digital Object Identifier 10.1109/MCOM.2008.4623715.
5. New innovations in Ethernet: Provider Link State Bridging by Peter Ashwood-Smith, Nigel Bragg, David Allan in Nortel Technical Journal, 2008, //www.nortel.com/corporate/news/collateral/ntj6_plsb.pdf.
6. Provider Link State Bridging (PLSB) by Don Fedyk, and Paul Bottoroff (contributor), 2009, //www.ieee802.org/1/files/public/docs2007/aq-fedyk-provider-link-state-bridging-0107-01.pdf.

What is claimed is:

1. A network, comprising:
a plurality of switches and/or routers configured to implement a native Ethernet routing protocol that encapsulates virtual private network (VPN) traffic with an invariant encapsulation attachment point Ethernet source address, with an invariant de-encapsulation attachment point Ethernet destination address, and with an invariant service label that uniquely identifies the VPN within the network.

2. The network of claim 1, wherein said Ethernet routing protocol eliminates use of label distribution protocol (LDP) operations and RSVP-TE operations in the network.

3. The network of claim 1, wherein said Ethernet routing protocol eliminates use of border gateway protocol (BGP) operations in the network.

4. The network of claim 1, wherein said Ethernet routing protocol eliminates use of egress-specific VPN labels in the network.

5. The network of claim 1, wherein said plurality of switches and routers are configured to forward encapsulated VPN traffic to the Ethernet destination address using a shortest path protocol without transit modification of the frames after encapsulation until de-encapsulation.

6. The network of claim 1, wherein the service label comprises a multi-protocol label switching (MPLS) header.

7. The network of claim 1, wherein the de-encapsulation attachment point Ethernet destination address comprises a destination media access control (MAC) address and where the encapsulation attachment point Ethernet source address comprises a source MAC address.

8. The network of claim 1, wherein the plurality of switches or routers are identified as components of an Ethernet backbone and wherein the service label uniquely identifies the VPN within the Ethernet backbone.

9. The network of claim 1, wherein the switches and/or routers are configured to correlate, for a VPN label, the network address space to VPN address space reachability relationships for at least one layer 2 VPN transported over the network.

10. A network component, comprising:
an Ethernet routing module configured to encapsulate virtual private network (VPN) traffic with an encapsulation attachment point Ethernet source address of the Ethernet routing module, with a de-encapsulation attachment point Ethernet destination address, and with a service label that uniquely identifies the VPN within a network associated with the network component.

11. The network component of claim 10, wherein the service label comprises a multi-protocol label switching (MPLS) header.

12. The network component of claim 10, wherein the encapsulation attachment point Ethernet source address comprises an origination media access control (MAC) address of the Ethernet routing module and wherein the de-encapsulation attachment point Ethernet source address comprises a destination media access control (MAC) address.

13. The network component of claim 10, wherein the network comprises a network backbone and wherein the service label uniquely identifies the VPN within the network backbone.

14. The network component of claim 10, wherein the Ethernet routing module is configured to correlate, for a VPN label, a network address space to VPN address space reachability relationships for at least one layer 2 VPN transported over the network.

15. The network component of claim 10, wherein the Ethernet routing module avoids label distribution protocol (LDP) operations, border gateway protocol (BGP) operations, and egress-specific VPN labels.

16. A method, comprising:
receiving, by a processor, a Virtual Private Network (VPN) packet; and
encapsulating the VPN packet with an encapsulation attachment point Ethernet source address, with a de-encapsulation attachment point Ethernet destination address, and with a service label that uniquely identifies the VPN within a network.

17. The method of claim 16, wherein the service label comprises a multi-protocol label switching (MPLS) header.

18. The method of claim 16, wherein the encapsulation attachment point Ethernet source address comprises an origination media access control (MAC) address and wherein the de-encapsulation attachment point Ethernet destination address comprises a destination media access control (MAC) address.

19. The method of claim 16, further comprising identifying an Ethernet backbone of the network and using the service label to uniquely identify the VPN within the Ethernet backbone.

20. The method of claim 16, further comprising correlating, for a VPN label, a network address space to VPN address space reachability relationships for at least one layer 2 VPN transported over the network.
